(19) United States
(12) Patent Application Publication
(10) Pub. No.: US 2017/0080885 A1
(43) Pub. Date: Mar. 23, 2017

(54) INEXPENSIVE, PRE-FINISHED AUTOMOTIVE BUMPER AND BUMPER COVER FIXER-STYLER

(71) Applicant: Paul M. Swamidass, Auburn, AL (US)

(72) Inventor: Paul M. Swamidass, Auburn, AL (US)

(21) Appl. No.: 14/859,281

(22) Filed: Sep. 19, 2015

(51) Int. Cl. B60R 19/44

(52) U.S. Cl. CPC B60R 19/445

(57) ABSTRACT

Modern automotive bumpers are set behind esthetically-pleasing molded thermoplastic or polymer-based bumper covers that are easily damaged, cracked or scratched. Replacing or repairing them is very labor intensive; most of the manual labor cost is associated with restoring the bumper's or bumper cover's finish to match the original finish on the automobile. This invention is a device or system that can do away with expensive custom finishing of repaired bumpers and bumper covers. Additionally, this pre-finished device or system adds selected color, texture, patterns, pictures, or messages to the repaired and restored bumper or its cover without having to incur the expense of custom refinishing. The prefinished bumper fixer-styler allows the car owner to restyle the car's appearance too.

### FIELD OF INVENTION

The present invention relates to a novel method of reducing the cost of automotive repair, particularly the repair of bumpers and bumper covers that are more prone to scratches and damage. Further, this invention relates to customized styling of automobiles by car owners.

### BACKGROUND OF THE INVENTION

Bumper Covers

Modern automotive bumpers are set behind esthetically-pleasing molded thermoplastic or polymer-based bumper covers that are easily damaged or scratched. Replacing or repairing them is very labor intensive; most of the manual labor cost is associated with restoring the bumper cover's painted finish to match the original paint on the automobile. While the cost of the molded, unfinished bumper cover alone may be about one-tenth of the total cost of the custom-painted repair, there is a real need to bring down the cost of bumper cover repairs by eliminating the costs associated with custom painting and color-matching after the repair. Many car owners would like to repair their bumper covers for less than what it costs today, and insurance companies too would like to reduce the cost of repairing bumper covers. This invention could reduce the repair to a bumper cover to less than insurance deductible. Thus, the car owner could fix the bumper cover without invoking auto insurance and risk higher premium.

This invention is a device or system that addresses two significant problems facing car owners with a small or moderate damage to the bumper cover in modern cars that come from the factory with paints matching the exterior of the car. The first problem concerns the excessive cost of repair of the bumpers because custom painting of the bumpers to match the exterior color of the automobile is time-consuming and labor-intensive, and the cost of acquiring matched paints is significant. This invention eliminates expensive custom repainting of the repaired bumper cover.

The second problem is the lack of distinctiveness of automotive bumpers for some auto owners. New car manufacturers make bumper covers that are molded and painted to blend with the rest of the exterior of the car. Auto owners, who are interested in creating distinctive bumper covers to match their life-style or self-image, can change the appearance of the damaged bumper cover and make a bold statement by using this pre-finished invention at a fraction of the cost for repairing and re-painting.

Additionally, those auto owners, who want to make a bold statement inexpensively, could purchase and install painting-free replacement for their undamaged bumpers for a very low cost.

Auto Bumpers Without Covers

Some automobiles and trucks do not have bumper covers but have finished bumpers. Minor damage or scratches to bumpers may be covered by attaching this prefinished device with adhesive backings and/or mechanical fastening devices to restore or enhance the esthetically pleasing look of the bumper that is scratched or slightly damaged; this device is not recommended when the bumper is too damaged to serve the original purpose as a bumper. A severely damaged bumper will need replacement.

This invention is a prefinished bumper segment with adhesive backing that can be fastened to the bumper using the adhesive backing and/or mechanical fasteners to cover scratches and minor damages to restore or to add styling to the car.

### Description of Prior Art

The prior art on bumper cover repair invariably uses expensive, labor-intensive repainting. The cost, time and expertise needed to conduct a professional bumper-cover replacement or repair is out of reach for most car owners; therefore many owners drive their cars with the damaged bumper.

U.S. Pat. No. 5,653,835 and US patent application 2006002978A1 exemplify the problem. They teach that the repair of automobile bumper covers require extensive preparation, priming and painting.

### SUMMARY OF THE INVENTION

The novelty of this prefabricated, prefinished repair and replacement bumper invention is that it gets rid of the expensive, labor-intensive custom-painting of the repaired cover to match the exterior of the car. Entire bumper covers for cars or segments of the contoured bumper covers will be prefabricated and painted in large quantities in factories for cost economies. These factory-produced segments of bumper covers will be inexpensive substitutes for custom-repaired and custom-painted bumper covers. Without the need for custom priming and repainting, this invention enables repairs of bumper covers in a fraction of the time needed to do the conventional repair.

This invention eliminates the need for the search and acquisition of expensive automotive paints that match an old car. This invention enables the do-it-yourself owner to quickly repair the damaged or scratched bumper cover for a small fraction of the cost of repairing the same scratch and damage using existing methods that require custom repainting with matched colors. Do-it-yourselfers could easily repair their bumper covers using this invention for less than the insurance deductible, and thereby avoid insurance premium increase by doing it themselves with this invention.

Using this invention, a do-it-yourselfer could fix a damaged bumper in about an hour, whereas, in the conventional methods, the repair, priming and repainting may take several days. The skill needed to use the present invention to fix the bumper cover in about an hour is far less than the skill needed to fix the damage to the bumper cover, and to prime and repaint it to match the exterior of the car.

Additionally, this pre-finished device for repairing bumper covers adds car-owner selected color, texture, patterns, pictures, or messages to the repaired and restored bumper without having to incur the expense of repainting to match the car's original color. A car owner could select from a choice of pre-painted repair segments offered by vendors to attach to the old bumper cover to make a bold statement about the looks of the car or a personal statement about the car's owner. Thus, this invention allows the car owner to select a color or design to restyle the car's appearance after a scratch and damage to the bumper cover.

Owners may fasten this device to undamaged bumpers or bumper covers to change the appearance of their automobiles.

### An Embodiment For Bumper Covers

While this invention concerns bumpers and bumper covers, the embodiment described below is in the context bumper covers. An embodiment of this invention for metallic bumpers without covers is a simple extension of the embodiment below.

### BRIEF DESCRIPTION OF THE DRAWINGS

FIG. 1 shows a typical bumper cover without blemish for a modern automobile.

FIG. 2 shows a bumper cover in FIG. 1 with scratches and damage.

FIG. 3 shows a prepainted repair segment of the bumper cover painted with an attractive, distinctive pattern different from the original color of the bumper cover.

FIG. 4 shows the pre-painted repair segment attached to the original damaged bumper cover using adhesives or mechanical means to give a distinctive look to the automobile, while repairing the bumper and adding to the mechanical properties of the bumper.

FIG. 5 shows the pre-painted repair segment that extends the entire length of the bumper cover.

FIG. 6 shows two embodiments of the mechanical attachment of the repair segment to the old damaged or undamaged bumper cover. Many embodiments are possible for mechanically attaching the repair segment to the old bumper cover.

FIG. 7 shows adhesive-backed polymer sheets manufactured in various colors without need for painting have vertical and horizontal ridges that enable their application on old plastic bumpers to conform to any contour on the bumper being repaired or restyled. The sheet may be cut to the shape of the bumper being repaired or restyled.

### DETAILED DESCRIPTION OF THE DRAWINGS

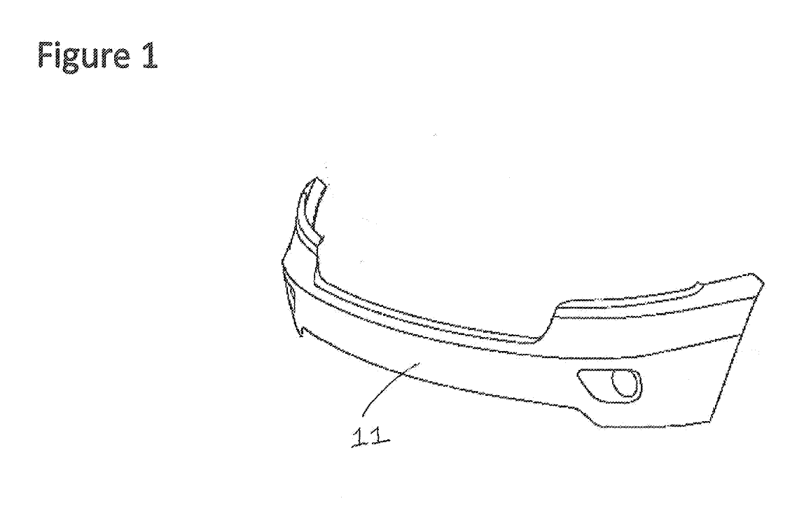

FIG. 1 shows the complex contours of the molded bumper cover 11 made of thermoplastics/polymers. Because of the complex three-dimensional shape, and because the bumper covers are primed and painted to match the exterior of the rest of the car, repairing even a small damage or scratch is very expensive. Unpainted replacement bumpers cost about a tenth of the cost of custom painting to match the car's exterior.

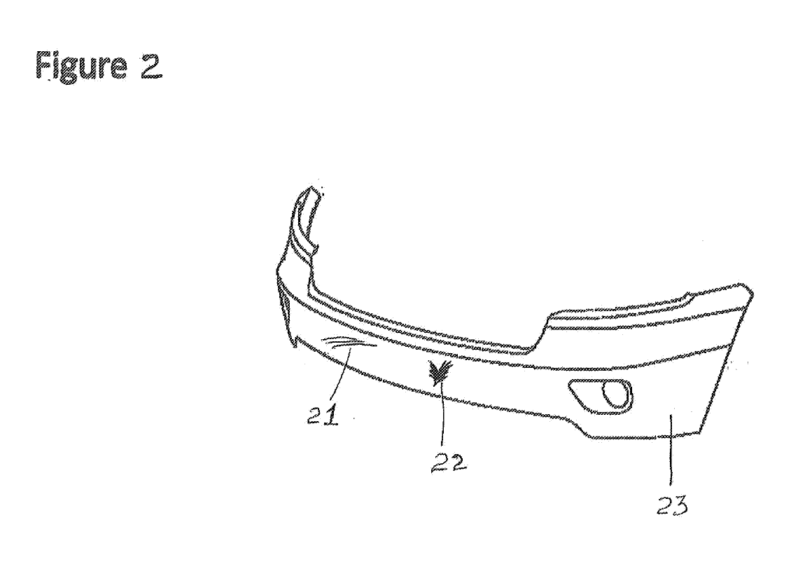

FIG. 2 shows scratches 21 and a small damage 22 to a bumper cover that needs repair. Cracks and other damages to the bumper cover may be chemically and mechanically fixed using commercially available epoxy-based repair kits. Once the damage is fixed, this invention does not require the time-consuming and expensive finishing of the repaired area with paints that match the car's exterior finish. This invention eliminates the expensive and time-consuming painting process of the repaired bumper cover.

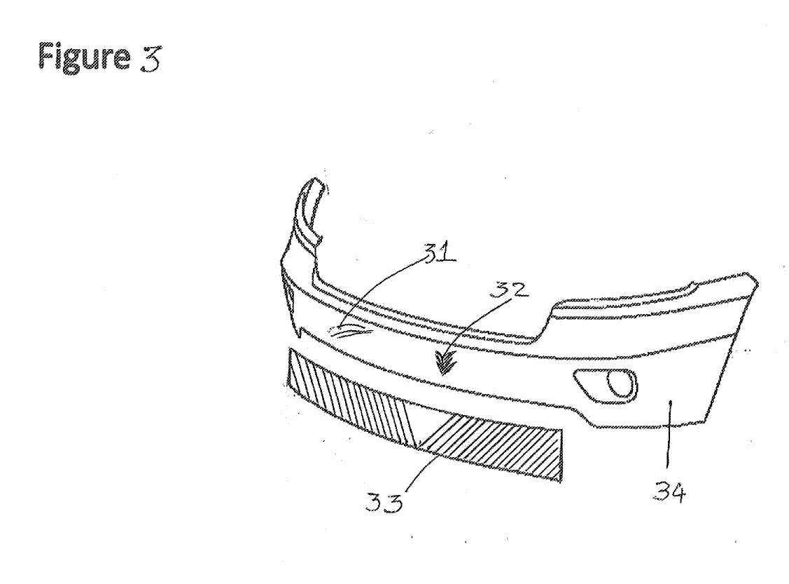

FIG. 3 shows the prefinished bumper repair segment 33 in front of the damaged bumper cover with scratch 31 and damage 32 that will be covered by 33. Replacement segment 33 is molded or made otherwise to conform to the contours of the bumper cover and may come with self-adhesive backing and/or mechanical retaining systems to structurally enhance the mechanical properties of the existing bumper cover once item 33 is fastened to the old bumper cover.

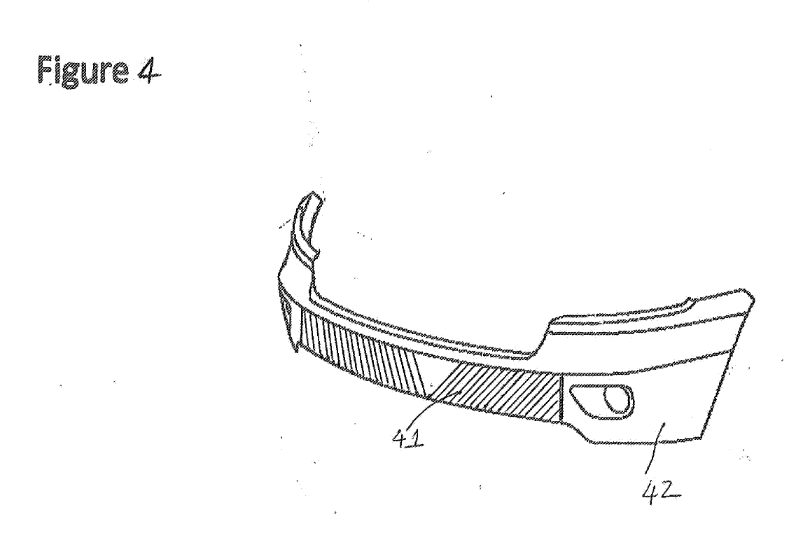

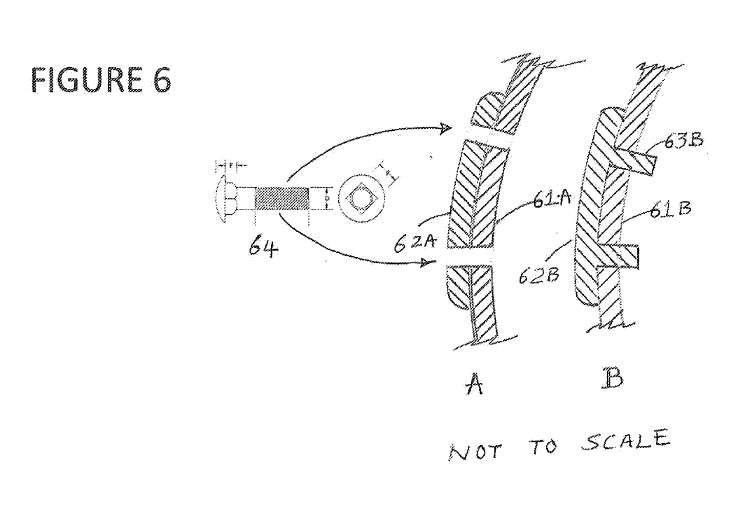

FIG. 4 shows the auto bumper cover with the repair segment 41 attached such that the scratch and damage to the old bumper are now hidden. Repair segment 41 may come with pressure-sensitive adhesive backing and/or mechanical attachments described below in FIG. 6. The car gets a new and enhanced appearance. The repair is concluded inexpensively without the need for priming and painting a match color with the exterior of the car.

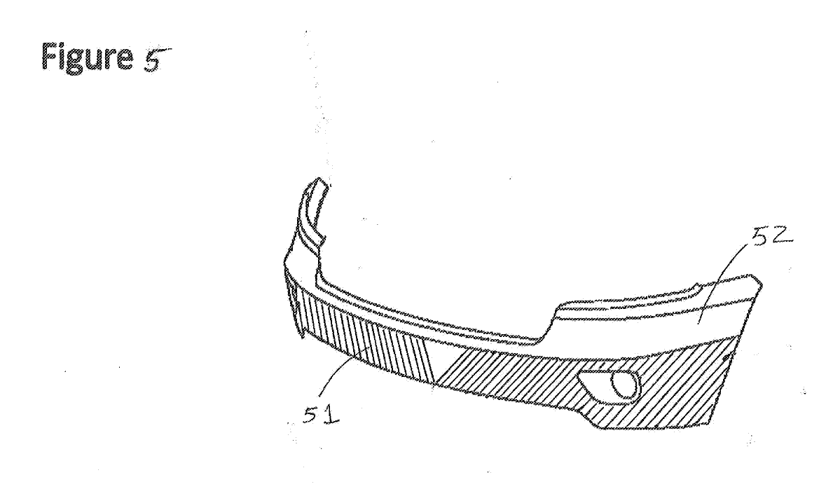

FIG. 5 shows that a larger area from one end to the other end of the old bumper could be transformed with a larger repair segment 51 that also covers the scratch and damage to the old bumper cover. The visible improvement to the looks of the car while repairing and adding mechanical properties to the old bumper are novel and unique benefits of this system.

Two embodiments of mechanical attachment are shown in FIGS. 6A and 6B. In the first embodiment in FIG. 6A, a vertical cross-section of the bumper cover 61A and prefabricated, pre-painted repair segment 62A are held together mechanically by several nuts and bolts 64 with or without an adhesive between the old bumper cover 61A and the attachable repair segment 62A. If an adhesive is used, the two cannot be separated. Mechanical attachments would allow the owner to replace the repair segment periodically to give a new look to the car bumper and the entire car. This is truly novel and it is relatively inexpensive to change the appearance of the car, anytime at the option of the owner.

In the second embodiment for mechanical attachment in FIG. 6B, holes are drilled in bumper cover 61 B to receive repair segment 62B with retainers 63B that may be threaded to receive retaining nuts or may be unthreaded but containing locking devices that clamp 63B to old bumper cover 61 B by pushing the repair segment 62B firmly against 61B.

### Second Embodiment for Bumper Covers

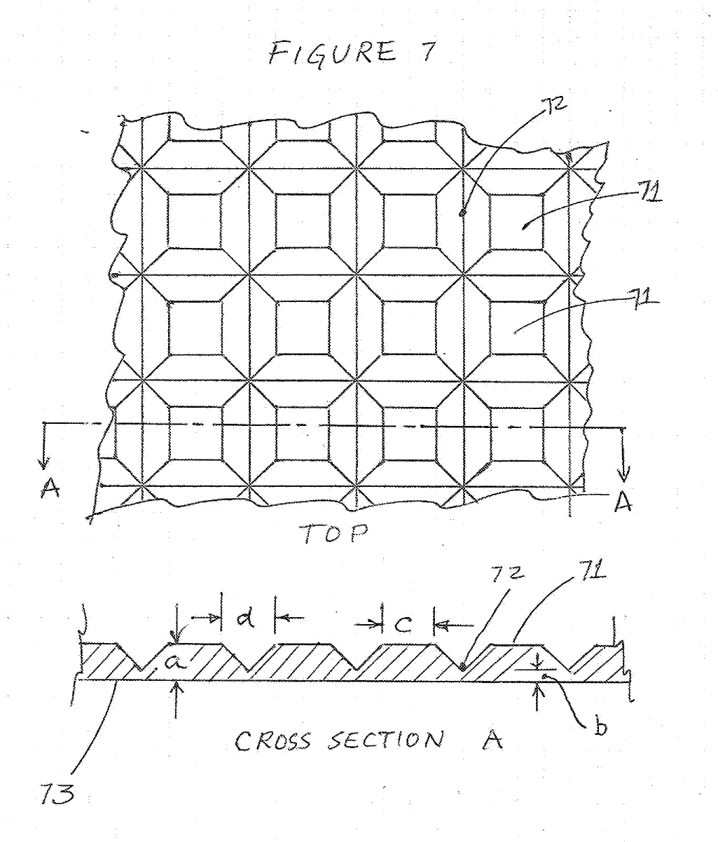

Polymer sheet 71 shown in top view and cross-section A in FIG. 7 may be cut to the shape of a bumper being repaired or restyled and affixed to the bumper. Horizontal and vertical ridges 72 enable the sheets to conform to the contour of the bumper cover. Pieces of the sheet may be cut to the shape of the bumper to be repaired or restyled and affixed to the old bumper using the adhesive backing 73. The thickness “a” of the sheet at its maximum does not bend but the smaller thickness “b” at the bottom of the ridge 72 is such that it is easily bendable to help the sheet hug the contour of the old bumper being repaired or restyled. Sheets may be manufactured to various combinations of dimensions “c” and “d” to enable the sheets to conform to the shape of the old bumper cover, and to vary the appearance of the repaired bumper. Sheets can be mass produced in various colors and polish such that they can be used without the need for painting.

What is claimed:

1. A low-cost, pre-finished, factory-produced device or system for repairing or replacing the full bumper cover that is scratched, damaged or undamaged, comprising:
a. full replacement auto bumper cover unit that is molded in conformity with the shape of the OEM bumper cover being repaired or replaced without compromising mechanical properties;
b. full replacement of auto bumper cover that are produced in volume, and prefinished by the manufacturer with automotive grade primer and painting;
c. full replacement of automotive bumper covers that are pre-finished with primer and automotive paint in monochrome colors that may or may not conform to any of the OEM colors for the car;
d. full replacement bumper covers pre-finished with primer and paint in various textures, patterns, logos, pictures and messages;
e. full replacement bumpers secured to the automobiles in exactly the same manner on the automobile as the original cover it replaces.

2. A low-cost, pre-finished, factory-produced device or system for repairing less than the full bumper cover that is scratched, damaged or undamaged, comprising:
a. partial segments of auto bumper cover that are molded in conformity with the shape of the OEM bumper made of materials and sufficient thickness to provide mechanical properties to the segment that are equal to or better than the original undamaged bumper cover;
b. partial segments of auto bumper cover that are mass produced, and prefinished by the manufacturer with automotive grade primer and painting;
c. partial segments of automotive bumper covers that are pre-finished with primer and automotive paint in monochrome colors that may or may not conform to any of the OEM colors for the car;
d. partial segments of bumper covers pre-finished with primer and paint in various textures, patterns, logos, pictures and messages;
e. partial segments of the bumper covers made in factories with pressure-sensitive adhesive backing;
f. partial segments of bumper covers attached permanently by the pressure-sensitive adhesives backings to the damaged bumper cover, and/or semi-permanently, mechanically fastened whereby it hides and covers scratched and damaged portions of the existing bumper cover while adding mechanical properties to the old damaged bumper cover.

3. Device in claim 2 may be used to cover scratches or minor damages to restore appearance and the style of finished bumpers without bumper covers;
a. the device may be fastened to finished bumpers with the use of adhesive backing or by mechanical fasteners;

4. Device in claim 1 may be embedded with reinforcements using metal wire, fabric or other fiber mesh to add mechanical properties to the bumper cover, and increase the strength and integrity of the bumper cover after the repair using this device or system.

5. Device in claim 2 may be embedded with reinforcements using metal wire, fabric or other fiber mesh to add mechanical properties to the bumper cover, and increase the strength and integrity of the bumper cover after the repair using this device or system.
